(19) United States
(12) Patent Application Publication
(10) Pub. No.: US 2009/0189068 A1
(43) Pub. Date: Jul. 30, 2009

(54) DETECTION OF SILICA SPECIES IN HOT PHOSPHORIC ACID

(76) Inventor: Harmesh K. Saini, Sunnyvale, CA (US)

Correspondence Address: Haynes and Boone, LLP;IP Section, 2323 Victory Avenue, SUITE 700, Dallas, TX, 75219, US

(21) Appl. No.: 12/245,587

(22) Filed: Oct. 3, 2008

Related U.S. Application Data
(63) Continuation of application No. PCT/US2007/066190, filed on Apr. 6, 2007.
(60) Provisional application No. 60/744,470, filed on Apr. 7, 2006.

(51) Int. Cl. B01D 59/44; H01J 49/00

(52) U.S. Cl. 250/282; 250/281

(57) ABSTRACT

In one embodiment, a method of analyzing silica species in a phosphoric acid solution includes the acts of: processing a sample of the phosphoric acid solution through an anion exchange resin to provide a processed sample; and analyzing the processed sample to determine a concentration of at least one silica species in the phosphoric acid solution.

### RELATED APPLICATION

This application is a continuation of International Application No. PCT/US2007/66190, filed Apr. 6, 2007, which in turn claims the benefit of U.S. Provisional Application No. 60/744,470, filed Apr. 7, 2006, the contents of both applications being incorporated by reference in their entirety.

### TECHNICAL FIELD

The present invention relates to automated process control of semiconductor bath quality, and more particularly to the detection of silica and related species in hot phosphoric acid.

### BACKGROUND OF THE INVENTION

Etching in hot phosphoric acid is a conventional semiconductor processing technique to remove selected portions of silicon nitride layers (Si₃N₄) without etching silicon dioxide (SiO₂). Although etching rates of silicon nitride in hydrofluoric acid (HF) is considerably faster than that in phosphoric acid, the use of heated phosphoric acid is the dominant technique because of the great selectivity hot phosphoric acid shows for silicon nitride over silicon dioxide (in excess of 40:1). Because hydrofluoric acid has much lower selectivity, it is typically used only for wafer reclaim operations.

Although hot phosphoric acid baths have been successfully used for the etching of silicon nitride for many years, the chemistry involved is surprisingly ambiguous and unknown. For example, it is believed that the concentration of silica (silicon dioxide) species in the bath strongly influences both silicon nitride etch rates and selectivity. However, the specific chemical reactions by which silicon nitride decomposes into silica species are subject to considerable conjecture. One popular model has silicon nitride reacting as follows

Si₃N₄+4H₃PO₄+12H₂O→3Si(OH)₄+NH₄H₂PO₄

It may be seen that in the preceding model, the silica exists in solution as ortho-silicic acid whereas the nitrogen has formed ammonium phosphate. But another model has the silicon nitride decomposing as:

Si₃N₄+H₃PO₄+H₂O→NO+NO₃+H2PO4+H₂SiO₃

such that the silica exists in solution as silicic acid (H₂SiO₃).

A dominant reason for the preceding chemical ambiguity is the difficulty of analyzing silica and related species concentration in a hot phosphoric acid bath. The phosphoric acid matrix interferes with standard silica analytical methods such as colorimetry and inductively-coupled-plasma mass spectrometry (ICP-MS). The matrix may be reduced through dilution but the degree of dilution necessary for a sufficient matrix reduction tends to lower the silica levels into undetectable or noisy ranges. In addition, ICP-MS techniques can typically identify only elemental silicon, not speciated forms of silicon. Moreover, as samples of hot phosphoric acid bath cool for offline analysis, the silica has a tendency to precipitate, further complicating the analysis. Finally, although the baths are filtered continually to remove precipitates, a substantial amount of insoluble silica is dispersed in the bath in the form of colloidal, polymeric, or monomeric silica. Such forms have a particulate size too small to be effectively filtered from the bath.

Although existing methods have failed to characterize the silica concentration (either dissolved, or both dissolved and precipitated), research has shown that the bath silica concentration is extremely important with regard to resulting wafer quality. As the silica concentration rises in the bath, the etch rate of silicon dioxide is greatly reduced. Because a selectivity for silicon nitride etching is preferred, semiconductor manufacturers typically “season” a bath prior to use by etching silicon-nitride-coated test wafers. However, it is completely unknown at present whether the beneficial effects of silica are derived from insoluble forms or soluble forms. Moreover, because the analytical tools are currently insufficient, a manufacturer has no real concept of whether the bath silica concentrations are good or bad.

Accordingly, there is a need in the art for improved analytical tools and techniques for the analysis of silica species in hot phosphoric acid solutions.

### SUMMARY

In accordance with an aspect of the invention, a method of analyzing silica species in a phosphoric acid solution includes the acts of: processing a sample of the phosphoric acid solution through an anion exchange resin to provide a processed sample; and analyzing the processed sample to determine a concentration of at least one silica species in the phosphoric acid solution.

In accordance with another aspect of the invention, a system for characterizing a silica species in a hot phosphoric acid bath is provided. The system includes: a sample extraction module operable to extract a sample of known volume from the hot phosphoric acid bath; a sample dilution and spike module operable to dilute the extracted sample to provide a diluted sample and to mix the diluted sample with a spike to form a spiked sample; a column packed with anion exchange resin to reduce a concentration of an acidic matrix in the spiked sample to provide a treated sample; an atmospheric pressure ionizer operable to ionize the treated sample to produce ions; a mass spectrometer operable to process the ions to provide a ratio response; and a control system operable to control a cyclic extraction of samples, dilution of the samples, spiking of the diluted samples, treatment of the spiked diluted samples through the column, ionization of the treated samples, processing of the ions to provide ratio responses, and processing of the ratio responses to characterize the concentration of the silica species in the hot phosphoric acid bath over time.

The invention is not limited to the features and advantages described above. Other features are described below. The invention is defined by the appended claims.

### BRIEF DESCRIPTION OF THE DRAWINGS

FIG. 1 is a block diagram of an phosphoric acid matrix elimination module according to an embodiment of the invention;

FIG. 2 is a block diagram of an IPMS system incorporating the module of FIG. 1 according to an embodiment of the invention; and

FIG. 3 illustrates an exemplary spectrum from the IPMS system of FIG. 2.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

To address the problems in the prior art analysis of silica in hot phosphoric acid, a system is provided that removes the ortho-phosphoric acid matrix (H₃PO₄) while maintaining silica species in solution. As used herein, “silica species” shall refer to the various forms silica takes as it is etched out into the hot phosphoric acid bath. For example, ortho-silicic acid, silicic acid (H₂SiO₃), and/or a phosphate-silicate species (H₂PO₄⁻.H₂SiO₃) may be present in the bath. In addition, the silica may be present in polymeric and colloidal forms as well. Advantageously, the system disclosed herein does not require excessive dilution of the hot phosphoric acid bath samples. Indeed, in some embodiments, the samples may receive no dilution. Instead, the samples may remain relatively concentrated as compared to prior art techniques, thereby maintaining the silica concentration in detectable ranges. Given that silica is sparingly soluble in hot phosphoric acid, the dilution of the phosphoric acid matrix to unobjectionable concentrations would lower the dissolved silica species concentrations into vanishingly small ranges.

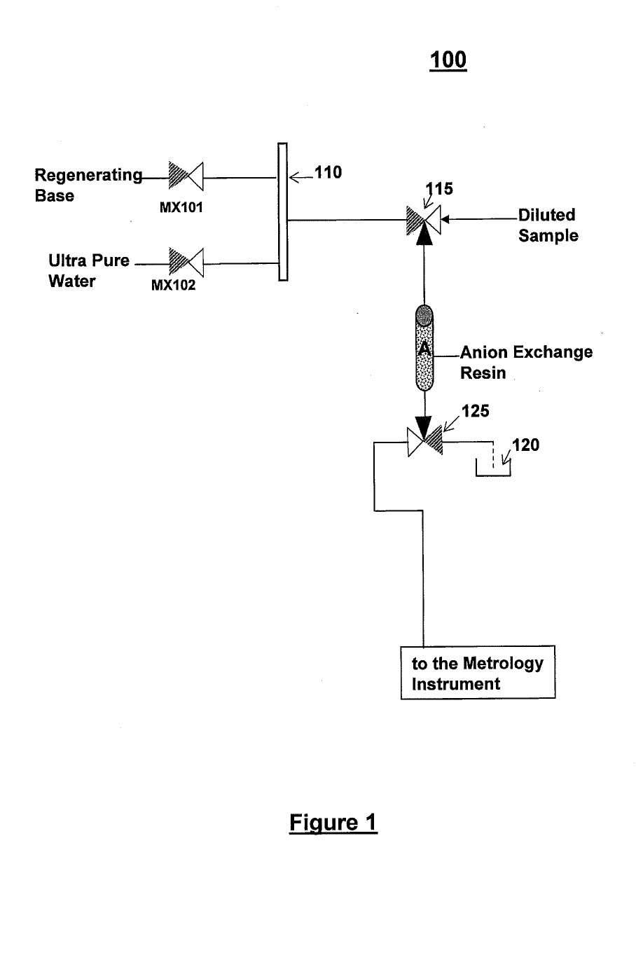

Turning now to FIG. 1, an exemplary phosphoric acid matrix removal module 100 is illustrated that preserves and stabilizes silicic acid species in solution. A sample is extracted from a hot phosphoric acid bath and may be diluted with an appropriate aqueous solvent such as UPW in a range of approximately 50:1. If a “closed loop” analysis is desired, the extracted sample may also be spiked with a known volume and concentration of a spike. For example, the spike may alter the naturally-occurring isotopic ratio of the silica specie(s) being characterized in an isotopic dilution mass spectrometry (IDMS) analysis. An IDMS analysis of silica species may be performed by spiking with a Si-29 analog of the silica species. For example, an analysis of the species H₂PO₄⁻.H₂SiO₃ may be performed in this fashion. Alternatively, the spike may be sufficiently similar in chemical behavior to the silicate specie(s) being characterized as performed in an internal standard analysis. In an “open loop” analysis, there is no need to spike the extracted sample. Instead, analytical results are compared to previously-obtained calibration data in the open loop technique. For example, a calibration curve may be obtained showing the response to 10 ppm silica, 15 ppm silica, 20 ppm silica, and so on. After processing through module 100, the extracted diluted and spiked sample is analyzed and the results compared to the calibration curve to determine the silica concentrations.

Diluted sample may be provided by a sample extraction module and a sample dilution and spike module (neither illustrated). An exemplary sample extraction module (SEM) is disclosed in U.S. patent application Ser. No. 11/298,738, filed Dec. 9, 2005, entitled “In-Process Mass Spectrometry with Sample Multiplexing,” the contents of which are incorporated by reference herein. As discussed in this application, an SEM may include a reservoir having a conduit connected to the bath. Vacuum is applied to the reservoir as commanded by a controller. The reservoir then fills with an extracted sample. By pressurizing the reservoir (e.g., as commanded by the controller) using a compressed gas source, the extracted sample is sent to the sample dilution and spike module. Alternatively, the sample may be taken from a pressurized recycle line for the bath such that a valve need merely be opened to allow sample to flow from the pressurized line.

An exemplary sample dilution and spike module is disclosed in U.S. Pat. No. 6,998,095, filed Aug. 15, 2003. In one embodiment of this module, sample fills a first loop or conduit attached to a first multi-way valve. Spike solution from a spike source fills a second loop attached to the first multi-way valve. The first multi-way valve may then be actuated such that the loops are connected with a diluent source such as a syringe pump containing a desired amount of diluent (e.g, UPW). The contents of the loops may then be mixed and diluted with the diluent. Should additional dilution be required, the diluted and spiked sample from the first multi-way valve may then be processed in additional dual-loop multi-way valves. It will be appreciated, however, that other techniques may be used to mix sample and spike solutions with appropriate diluents. Moreover, in some embodiment, no diluent is added to the spiked sample.

Although the phosphoric acid matrix concentration in the resulting diluted and spiked sample is reduced, analysis of silica species may still be hampered by the relatively high concentration of matrix that remains. The resulting relatively high concentrations of protons and phosphate ions obscure the detection and quantification of silica species because ionization of the more concentrated matrix ions is statistically more likely, for example, in the ionization source of a mass spectrometer. Similar matrix effects may hamper other analytical techniques such as colorimetry. Thus, the phosphoric acid matrix should be removed from the diluted and spiked sample to more accurately quantify the silica species concentrations.

To perform the matrix removal, the diluted sample is selected for at a three-way valve 115 to flow into a column A packed with an anion exchange resin. It will be appreciated that the term “column” is merely used to refer to a container that may hold the resin. Thus, this term is not limited to describing a container having a columnar shape but may refer to any suitable container for the resin. Moreover, the term “eliminated” or “removed” with respect to the phosphoric acid matrix is used with respect to the resulting analysis. In other words, matrix may considered “eliminated” if it is still present but sufficiently reduced such that an accurate analysis may be made upon the silicate species. The resin may comprise a weak anion exchange resin, a strong anion exchange resin, or a combination of these resins. In general, an ion exchange resin is an organic polymer to which active groups have been covalently attached. Depending on the properties of these groups, an ion exchange resin may be classified as either a cation or anion exchange resin. In an anion exchange resin, the functional or active groups that have been covalently bonded to the resin backbone are positively charged so that they may exchange negatively charged counter ions (anions). An anion exchange resin may be classified as either a weak or strong anion exchange resin depending upon the basicity of the active groups. As suggested by the name, the active groups in a weak anion exchange resin are weakly (rather than strongly) basic. Generally, a weak anion exchange resin uses tertiary amines or polyamines as the functional groups but it will be appreciated that numerous other functional or active groups having a sufficiently weak basicity (and suitability for covalent bonding to the resin) may also be used. As known in the art, the polymer backbone of a weak anion exchange resin may be based on synthetic polymers such as styrene-divinylbenzene copolymer, acrylic, polysaccharides, or many other suitable polymers. A weak anion exchange resin is generally supplied in the form of beads, which may either be dense (gel resins) or porous (macroporous resins). The technique disclosed herein is relatively insensitive to the particular form of the beads.

Because the active groups in a weak anion exchange resin are only weakly basic, they can be regenerated with a relatively weak base such as ammonium hydroxide. In contrast, a strong anion exchange resin may require regeneration with a stronger base such as sodium hydroxide. The use of sodium hydroxide can be problematic, particularly for mass spectrometry analytical techniques because of the sodium ions that will remain in the resin after regeneration. These sodium ions will elute off the column during analysis and thus interfere with both the ionization source of the mass spectrometer and its detection/spectral analysis. In contrast, ammonium ions left in the resin after regeneration are far less problematic. Accordingly, the following discussion will assume that the resin is a weak anion exchange resin so that a relatively weak base such as ammonium hydroxide may be used for regeneration.

As the phosphoric acid matrix flows into the resin, active sites such as tertiary amines are protonated. A protonated site will then associate with a phosphate anion resulting from the deprotonation of the phosphoric acid. In this fashion, the phosphoric acid is removed. Advantageously, it is believed that the protonated active sites do not significantly bind or retain the silica species. In addition, the resulting eluent from the regenerated resin will be basic, having a pH of approximately 9. This is advantageous because ortho-silicic acid has a pKa of approximately 9 as well. Thus, at a pH of 9, approximately one-half of the ortho-silicic acid will be ionized. At lower pHs, the ionized portion drops significantly such that the ortho-silicic acid solubility is enhanced by providing such a basic eluent. It will be appreciated, however, that other pH ranges may be utilized.

The treated eluent from the column may then pass through a three-way valve 125 to a metrology instrument (not illustrated) such as, for example, a mass spectrometer or a colorimeter. Because atmospheric pressure ionization (API) mass spectrometry preserves relatively large molecular weight species such as H₂PO₄⁻.H₂SiO₃, the remaining discussion will assume the metrology instrument is an API mass spectrometer such as, for example, an electrospray mass spectrometer. In contrast, the use of ICP-MS would indicate only the elemental concentration of silicon. To ensure that the eluent is properly treated, a first portion of the eluent may flow into a drain 120. The final portion of the eluent may then be selected for at valve 125 to flow to the API mass spectrometer.

After the diluted and spiked sample has been treated, the resin may be flushed with a solvent such as de-ionized water or ultra-pure water (UPW) through activation of a valve MX102 coupled to a manifold 110. The solvent may then flow through the manifold, valve 115, the column, valve 125, and into the drain. Regeneration may then occur by selecting for, for example, 2.0 M ammonium hydroxide solution through activation of a valve MX101 in a similar fashion as described for the solvent. The column may then be again rinsed with solvent so that another cycle of phosphoric acid matrix elimination may occur. It will be appreciated that module 100 is readily modified to allow for back-flushing of the column with the solvent and regenerating base.

Module 100 may be incorporated into an in-process mass spectrometry (IPMS) system. In an IPMS instrument, a processor controls an automatic sampling of the hot phosphoric bath, diluting and spiking the sample with a calibration standard (the spike), flowing the diluted and spiked sample through the anion exchange resin, ionizing the resulting processed sample, processing the processed sample through the mass spectrometer to produce a ratio response, and analyzing the ratio response to determine the amount of one or more silica species in the sample. Unlike prior art open loop techniques, response drifts are not a problem—the drift affects the spike and silica species in the same fashion and is thus cancelled in the ratio response. The addition of a known amount of spike to the sample “closes the loop” and provides accurate results. Thus, automated operation may be implemented without the necessity of manual intervention or recalibration. In addition, stable and reliable operation is assured by, in an embodiment, the use of atmospheric pressure ionization (API) such as electrospray to ionize the spiked sample. Moreover, the use of API preserves molecular species.

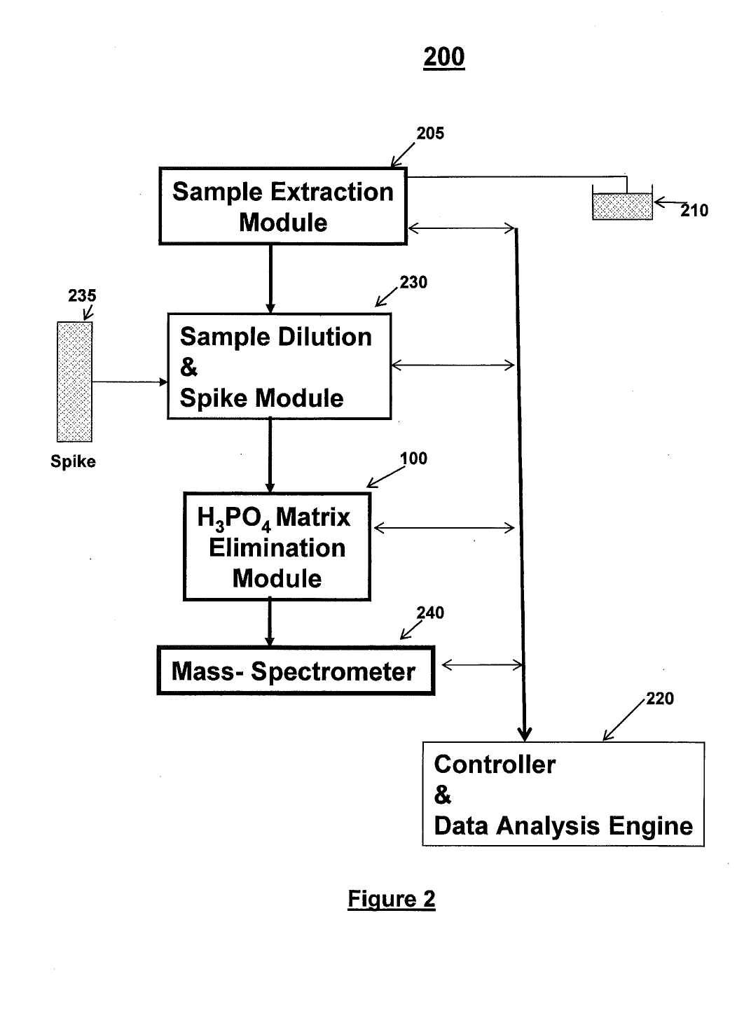

An exemplary IPMS system 200 is illustrated in FIG. 2. A sample extraction module 205 extracts a sample from a hot phosphoric acid bath 210 as discussed previously. The resulting extracted sample is spiked and diluted in a sample dilution and spike module 230 using a spike source 235. In alternative embodiments, the sample need not be diluted. Module 100 eliminates the phosphoric acid matrix as discussed with regard to FIG. 1. Processed sample may then be received at an API mass spectrometer 240.

Given the plurality of spikes and silica species that may be present in the ionized mixture being analyzed by the mass spectrometer, a variety of mass spectrometer tunings may be used. For example, various settings such as capillary voltages, skimmer voltages, pulser voltages, and detector voltage levels comprise a mass spectrometer tuning. Each tuning is used to characterize a certain mass range. For example, one tuning may be used to characterize analytes of relatively low molecular weight whereas another tuning may be used to characterize analytes of higher molecular weight. The range of masses observable for a given tuning may be denoted as a mass window. The mass windows may be identified by an element within the window. For each sample being processed by mass spectrometer 240, a plurality of mass windows will typically be analyzed. As disclosed in U.S. application Ser. No. 11/329,536, filed Jan. 11, 2006, the contents of which are hereby incorporated by reference, the one or more processors (not illustrated) in a controller 220 that control IPMS system 200 may be configured with a “data analysis engine” (DAE). The DAE uses the identity of the process solution being sampled and the mass spectrometer tunings to identify peaks of interest in the resulting mass spectrums from the mass spectrometer. The DAE performs a ratio measurement using the identified peaks to calculate the concentrations of the analytes.

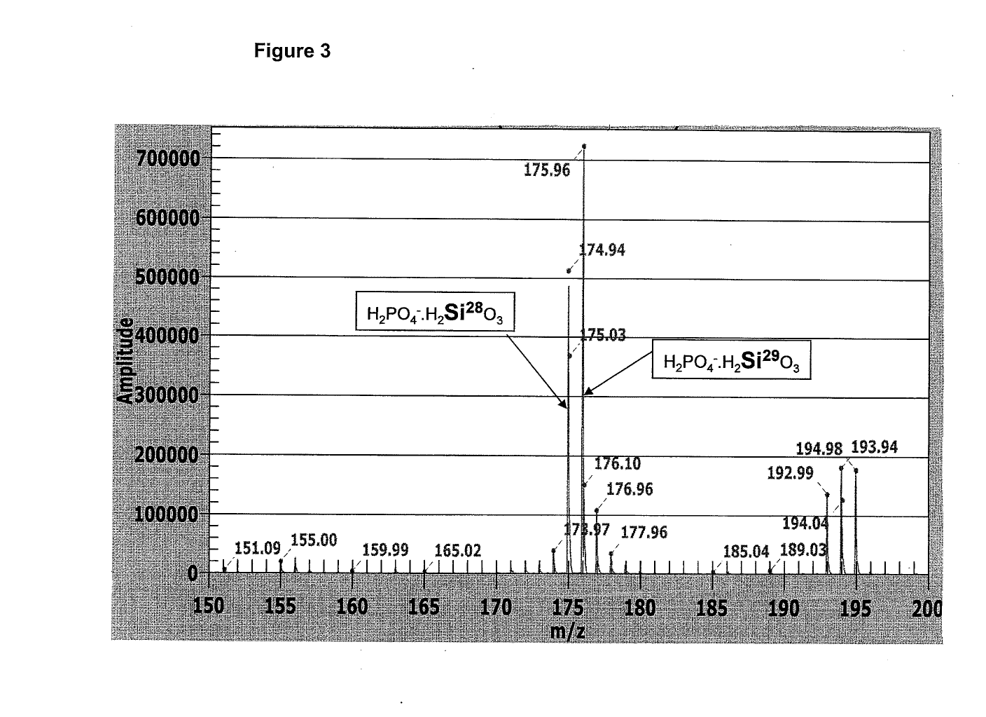

Advantageously, the controller controls the remaining components in the IPMS system such that continuous real time analysis of silica species may be performed on the bath. Each extracted sample that is processed through the IPMS system may be considered to correspond to an analysis cycle. The IPMS system cycles through such analysis cycles without the need for any human intervention. Moreover, molecular species are preserved such that the ambiguity regarding phosphoric bath chemistry may be resolved. Turning now to FIG. 3, an exemplary spectrum from mass spectrometer 240 is illustrated. In this example, the spike is created by dissolving Si²⁹O₂ in hot phosphoric acid to create a solution containing the isotopically-labeled silica species H₂PO₄⁻.H₂Si²⁹O₃ at a known concentration. This spike is then used as spike source 235. The concentration of the non-isotopically labeled species in the hot phosphoric acid bath may then be determined using a ratio measurement.

IPMS allows a manufacturer to monitor the bath to determine the optimum number of process conditioning wafers that must be processed to condition the bath. Process conditioning wafers are silicon-nitride-coated blank wafers that are processed like production material to bring the process to “stability” and re-qualify it for production after hot phosphoric acid bath change. The stability comes about through generation of desired silica species concentrations. Both the downtime associated with conditioning and the conditioning wafers are very expensive. The downtime and expense is aggravated by the necessary verification of bath performance using test wafers. By monitoring bath chemistry using IPMS, a manufacturer may use the optimum number of conditioning wafers that will bring the bath to “stability” in the shortest possible time. In this fashion, the bath downtime and the number of conditioning wafers used to condition the bath may be minimized. Moreover, a user may manage the “bleed and feed” rate of the bath based upon measuring the concentrations of one or more silica species in the bath. In addition, a user may manage the etch time for a given wafer in the bath based upon the measured silica specie(s) concentrations.

The described embodiments of the present invention are merely meant to be illustrative and not limiting. For example, the mass spectrometer need not utilize atmospheric pressure ionization such as electrospray but instead may utilize other ionization sources such as inductively-coupled plasma ionization. Moreover, the insoluble forms of silica in the bath may be solubilized by an initial treatment with a suitable acid such as hydrofluoric acid. Thus, the scope of the present invention is defined only by the following claims.

I claim:

1. A method of analyzing silica species in a phosphoric acid solution, comprising:
processing a sample of the phosphoric acid solution through an anion exchange resin to provide a processed sample; and
analyzing the processed sample to determine a concentration of at least one silica species in the phosphoric acid solution.

2. The method of claim 1, wherein the sample of phosphoric acid solution is diluted before processing through the anion exchange resin.

3. The method of claim 2, wherein the anion exchange resin is a weak anion exchange resin.

4. The method of claim 3, wherein the weak anion exchange resin comprises tertiary amines.

5. The method of claim 2, further comprising spiking the diluted sample with a spike before processing through the anion exchange resin.

6. The method of claim 5, wherein the spike comprises an isotopically-labeled silica species.

7. The method of claim 1, further comprising: managing the phosphoric acid solution based upon the determined concentration of the at least one silica species.

8. The method of claim 7, wherein the management comprises adjusting a bleed and feed rate for the phosphoric acid solution.

9. The method of claim 1, further comprising: providing a signal to a user if the determined concentration of the at least one silica species is outside of a desired range.

10. The method of claim 1, further comprising: etching a wafer in the phosphoric acid solution for a period of time selected responsive to the determined concentration of the at least one silica species.

11. A system for characterizing a silica species in a hot phosphoric acid bath, comprising:
a sample extraction module operable to extract a sample of known volume from the hot phosphoric acid bath;
a sample dilution and spike module operable to dilute the extracted sample to provide a diluted sample and to mix the diluted sample with a spike to form a spiked sample;
a column packed with anion exchange resin to reduce a concentration of an acidic matrix in the spiked sample to provide a treated sample;
an atmospheric pressure ionizer operable to ionize the treated sample to produce ions;
a mass spectrometer operable to process the ions to provide a ratio response; and
a control system operable to control a cyclic extraction of samples, dilution of the samples, spiking of the diluted samples, treatment of the spiked diluted samples through the column, ionization of the treated samples, processing of the ions to provide ratio responses, and processing of the ratio responses to characterize the concentration of the silica species in the hot phosphoric acid bath over time.

12. The system of claim 11, wherein the anion exchange resin is a weak anion exchange resin.

13. The system of claim 12, wherein weak anion exchange resin comprises a tertiary amine.

14. The system of claim 11, wherein the atmospheric pressure ionizer is an electrospray ionizer.

15. The system of claim 11, wherein the spike comprises an isotopically-labeled silica species.
